(19) United States
(12) Patent Application Publication
(10) Pub. No.: US 2013/0068704 A1
(43) Pub. Date: Mar. 21, 2013

(54) FUEL SYSTEM ICE SEPARATOR

(71) Applicant: Behzad Hagshenas, San Diego, CA (US)

(72) Inventor: Behzad Hagshenas, San Diego, CA (US)

(21) Appl. No.: 13/452,165

(22) Filed: Apr. 20, 2012

Related U.S. Application Data
(60) Provisional application No. 61/536,147, filed on Sep. 19, 2011.

(51) Int. Cl. B01D 21/26; B01D 12/00; B01D 37/00; B01D 29/00

(52) U.S. Cl. 210/787; 210/512.1; 210/348; 210/513; 210/172.1; 210/767; 210/800

(57) ABSTRACT

An example ice separator device includes an ice separator that removes ice particles from a flow of fuel moving through the ice separator.

### CROSS-REFERENCE TO RELATED APPLICATIONS

This application claims priority to U.S. Provisional Application No. 61/536,147, which was filed on 19 Sep. 2011 and is incorporated herein by reference.

### BACKGROUND

Fuel systems on aircraft have been known to build up ice inside of the fuel tank, and inside the fuel lines that feed equipment, such as the main engines and/or an auxiliary power unit. An auxiliary power unit is generally a small gas turbine engine that provides power to the aircraft. The power is utilized before the main engines have started, for example.

A source of water that forms the ice can be water already in a saturated fuel, or excess water that may occur due to condensation. There have been instances where the ice build-up in the fuel lines is suddenly released due to flow variations, vibration from turbulence, etc. This may result in a substantial amount of ice particles and/or chunks traveling down the fuel lines toward equipment. This finite quantity of ice could be high enough to obstruct the entrance to the equipment. Examples of the equipment could be a fuel oil heat exchanger, fuel pumps, etc.

### SUMMARY

An example ice separator device includes an ice separator that removes ice particles from a flow of fuel moving through the ice separator.

An example fuel delivery system for an aircraft includes a fuel tank, and a fuel line communicating fuel from the fuel tank to downstream equipment. An ice separator is positioned upstream of the equipment to remove ice particles that may be flowing with the fuel through the fuel line prior to the ice particles reaching the equipment.

An example method of separating ice particles from fuel includes utilizing movement of the flow of fuel to separate ice particles from flow of fuel delivered from a fuel supply to equipment.

### DESCRIPTION OF THE FIGURES

The various features and advantages of the disclosed examples will become apparent to those skilled in the art from the detailed description. The figures that accompany the detailed description can be briefly described as follows:

FIG. 1 shows an example ice separator device.

FIG. 2 shows a cross-sectional view of the FIG. 1 device.

FIG. 3 shows another example ice separator device.

FIG. 4 shows yet another example ice separator device.

FIG. 5 shows a schematic view of an example fuel delivery system.

### DETAILED DESCRIPTION

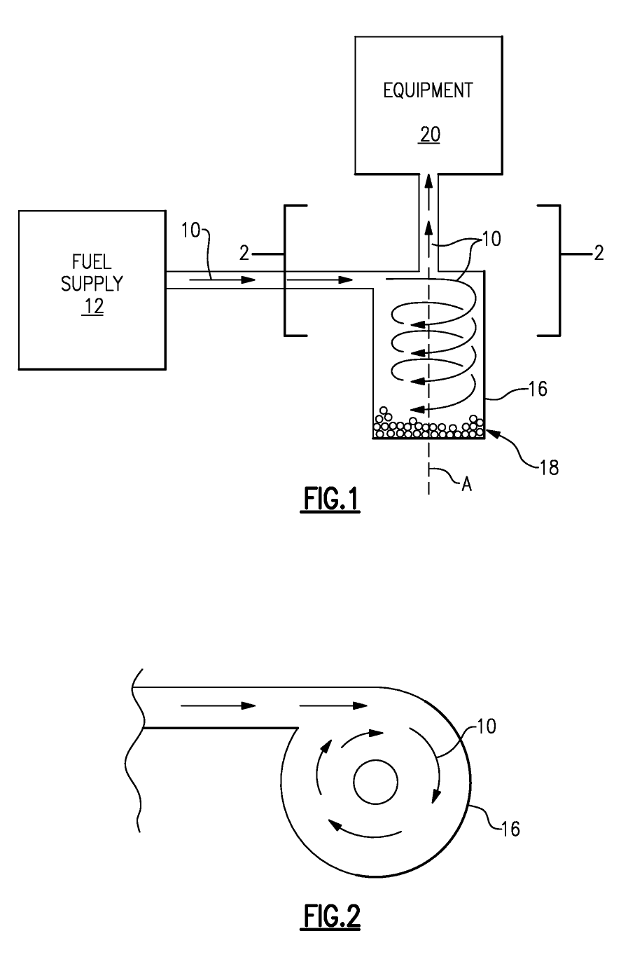

As shown in FIGS. 1 to 4, any number of relatively simple devices can be placed upstream of the equipment, and utilize the flow of the fuel to ensure that the ice chunks/particles released do not reach the entrance of fuel system equipment, such as a fuel pump, fuel/oil heat exchangers, or even a smaller connecting conduit downstream of a larger conduit. Thus, the equipment will continue to function properly during flight.

Referring to FIG. 1, a flow 10 of fuel from a fuel supply 12 is moved through an inertia-based particle separator device 16. A pump (not shown) moves the fuel in one example. Within the device 16, ice particles 18 carried by the flow 10 will separate due to centrifugal force and will fall to the bottom of the separator device 16. The size of the inertia particle separator device 16 depends on expected volume of ice particles 18 that need to be separated from the flow 10.

Referring to FIG. 2, the device 16 has a circular cross-section. The flow 10 enters the device 16 tangent to the device 16 as is shown. The flow 10 entering the device 16, and the geometry of the device 16, encourages the flow 10 within the device 16 to move along a spiraling path within the device 16. In this example, the flow 10 swirls about an axis A (FIG. 1). Flow 10 communicates from the separator device 16 to equipment 20 along the same axis A. The flow 10 communicating to the equipment 20 from the separator device 16 has fewer ice particles 18 than the flow 10 communicating to the separator device 16 from the fuel supply 12.

In another example, a post or another structure (not shown) may extend along the axis A of the device 16 for some distance. In the post example, the flow 10 within the device 16 would spiral around the post.

Referring to FIG. 3, another example separator device 30 includes a screen 32 positioned in the flow 10 of fuel flow path. The size of this separator device 30 (and some of the other disclosed devices) depends on expected volume of ice particles that need to be separated from the flow 10.

The screen 32 is cone-shaped or any other shape that may maximize the screen's surface area. A nose 34 of the screen 32 is upstream the other portions of the screen 32. The shape of the screen 32 and its positioning relative to the flow 10 encourages ice particles 18 to move across the screen 32 (and away from the nose 34.) This movement helps prevent the ice particles 18 from clogging areas of the screen 32, especially areas near the nose 34.

As appreciated, the screen 32 has holes. In one example, areas of the screen 32 furthest from the nose 34 do not include holes. Ice particles are not able to clog this area because there are no holes to clog. The cone shape of the screen 32 and its positioning relative to the flow 10 encourages ice particles 18 to move across the screen 32 to the areas without holes.

The size of the holes in the screen 32 depends in part on the passage opening in the downstream equipment, such as passages within a fuel-oil heat exchanger. In one specific example, the screen 32 has about 33 percent open area, and the holes are circular and have a diameter of about 0.060 inches (1.52 millimeters).

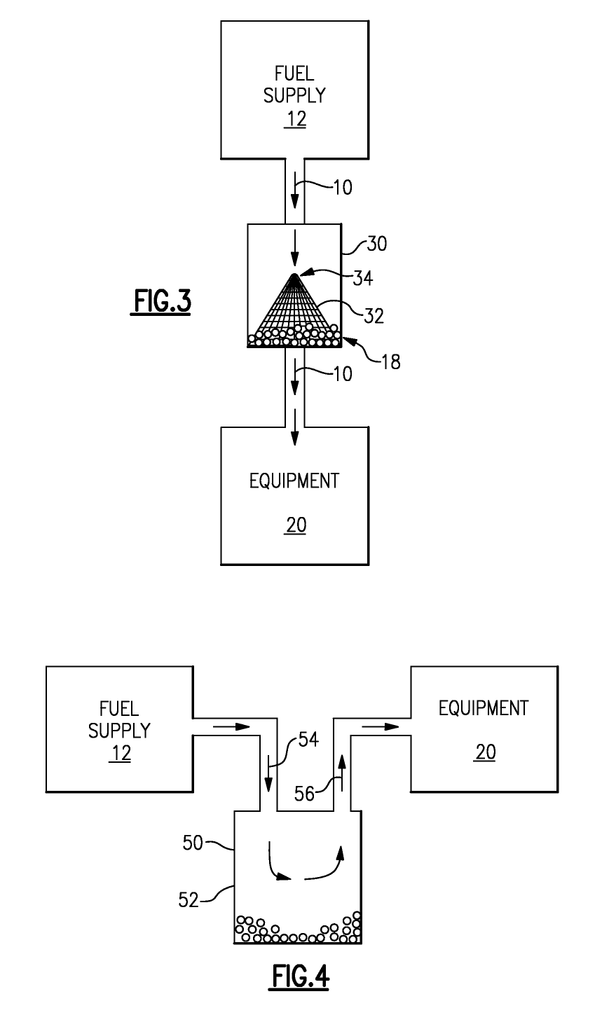

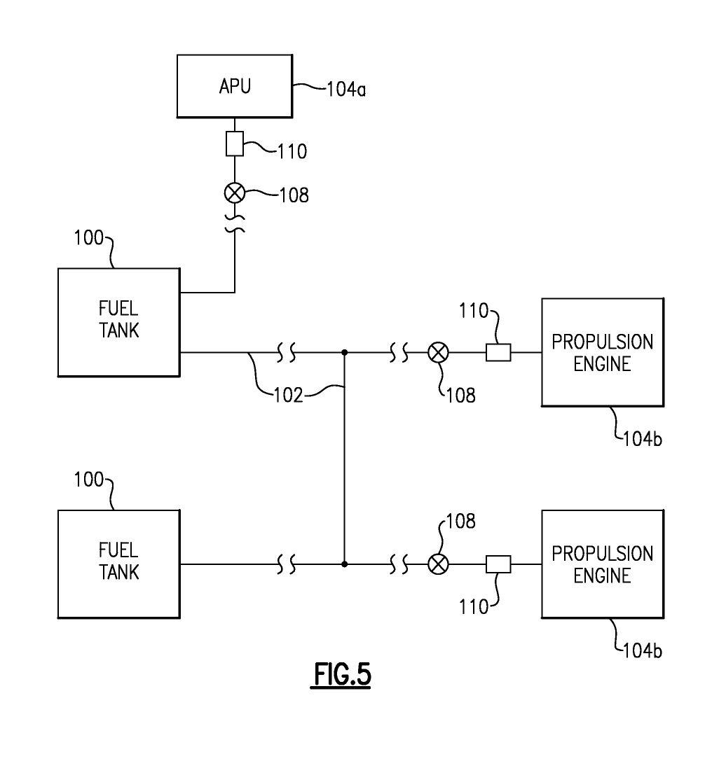

Referring to FIG. 4, yet another example separator device 50 comprises a settling tank 52. In this example device 50, a fuel inlet 54 and a fuel discharge 56 are both on a vertically upper end of the tank 52. Ice particles 18 settle near the vertically lower end surface of the tank 52 due to gravity. The settling tank 52 is sized to ensure low velocity such that the heavier ice particles settle at the bottom of the tank.

In addition to the examples of FIGS. 1 to 4, any number of other ways of providing an ice separation between a fuel tank and a piece of equipment may be utilized.

In these techniques, the collected ice will melt in time due to warmer fuel temperatures, or each device can be designed for inspection port and ice drainage provision after cold, long flights with saturated or supersaturated fuel.

FIG. 5 schematically shows an example fuel delivery system having fuel tanks 100, fuel lines 102, and downstream pieces of equipment, such as an APU 104a and propulsion engines 104b. Spar valves 108 control fuel movement through the fuel lines 102. As shown, separator devices 110 are positioned upstream the equipment 104a and 104b. The separator devices 110 prevent ice particles from entering the equipment 104a and 104b. Any of the example separator devices 110 in FIGS. 1 to 4 could be suitable for use as the separator devices 110.

Although embodiments have been disclosed, a worker of ordinary skill in the art would recognize that many modifications would come within the scope of this disclosure. Thus, the following claims should be studied.

1. An ice separator device, comprising:
an ice separator that removes ice particles from a flow of fuel moving through the ice separator.

2. The ice separator device of claim 1, wherein the ice separator is inertia-based and causes the flow to swirl around an axis to separate ice particles from the flow due to centrifugal force.

3. The ice separator device of claim 2, wherein flow moves from the ice separator along the axis.

4. The ice separator device of claim 2, including a post extending along the axis.

5. The ice separator device of claim 2, wherein the flow entering the ice separator causes the flow to swirl around the axis.

6. The ice separator device of claim 2, wherein the flow enters the device tangent to the device.

7. The ice separator device of claim 1, wherein the ice separator includes a cone-shaped screen.

8. The ice separator device of claim 7, wherein a nose of the cone-shaped screen is positioned upstream relative to a direction of flow through the ice separator.

9. The ice separator device of claim 1, wherein the ice separator comprises a settling tank having a fuel inlet and a fuel discharge that are both on a vertically upper end of a tank.

10. A fuel delivery system for an aircraft comprising:
a fuel tank, a fuel line communicating fuel from the fuel tank to downstream equipment; and
an ice separator positioned upstream of the equipment to remove ice particles that may be flowing with the fuel through the fuel line prior to the ice particles reaching the equipment.

11. The fuel delivery system of claim 10, wherein the ice separator is inertia-based and causes the flow to swirl around an axis to separate ice particles from the flow due to centrifugal force.

12. The fuel delivery system of claim 10, wherein the ice separator includes a cone-shaped screen.

13. The fuel delivery system of claim 10, wherein the ice separator includes a fuel inlet and a fuel discharge that are both on a vertically upper end of a tank.

14. The fuel delivery system of claim 10, wherein the downstream equipment is an auxiliary power unit.

15. A method of separating ice particles from fuel, comprising:
utilizing movement of the flow of fuel to separate ice particles from flow of fuel delivered from a fuel supply to equipment.

16. The method of claim 15, separating the ice particles utilizing centrifugal force.

17. The method of claim 15, separating the ice particles utilizing a cone-shaped filter.

18. The method of claim 15, removing the ice particles utilizing a settling tank having a fuel inlet and a fuel discharge that are both on a vertically upper end of a tank.
